(19) United States
(12) Patent Application Publication
(10) Pub. No.: US 2020/0386580 A1
(43) Pub. Date: Dec. 10, 2020

(54) SCALE ELEMENT FOR AN OPTICAL MEASURING DEVICE

(71) Applicant: PHYSIK INSTRUMENTE (Pl) GMBH & CO. KG, Karlsruhe (DE)

(72) Inventor: Rainer GLÖSS, Karlsruhe (DE)

(73) Assignee: PHYSIK INSTRUMENTE (Pl) GMBH & CO. KG, Karlsruhe (DE)

(21) Appl. No.: 16/971,569

(22) PCT Filed: Feb. 19, 2019
(86) PCT No.: PCT/DE2019/100157

§ 371 Date: Aug. 20, 2020

(30) Foreign Application Priority Data
Feb. 21, 2018 (DE) 10 2018 103 869.0

(51) Int. Cl. G01D 5/347; G01D 5/26

(52) U.S. Cl. CPC G01D 5/34792; G01D 5/34715; G01D 5/266

(57) ABSTRACT

The present disclosure refers to a scale element for an optical measuring device having an incremental encoder and an interferometric sensor system, the scale element having a reflection layer on one of the surfaces of the scale element, which reflection layer is provided to cooperate with the interferometric sensor system, and the scale element further having a material measure, which is arranged in a direction pointing away from and spaced apart from the reflection layer and is provided to cooperate with the incremental sensor system, the reflection layer being configured and designed in such a way that the reflection layer is transmissive for light of certain wavelengths and reflective for other wavelengths.

The invention refers to a scale element for an optical measuring device comprising two different sensor systems, namely an incremental encoder and an interferometric sensor system, according to claims 1 to 4. Furthermore, the invention refers to a positioning device with such a measuring device.

Measuring devices for detecting the position and the location of a positioning element comprising a plurality of degrees of freedom usually use sensor systems which have an associated scale element. The sensor systems can function according to capacitive, inductive or optical principles. If the measuring range of the sensor system exceeds the required resolution by more than the factor 100,000, incremental systems are required. For resolutions in the nanometer or picometer range, usually optical-incremental sensor systems are used.

In measuring devices for detecting the position and location of a positioning element with respect to three degrees of freedom, namely translation in the two directions X and Y, which are perpendicular to each other and in the same plane, and rotation about the direction Z perpendicular to X and Y, optical incremental encoders are advantageous because they permit high resolution and large travel ranges. The sensor heads of such incremental encoders can be designed to allow a large distance tolerance of a few millimeters. They thus enable the use of additional incremental sensors to determine the height or distance at, for example, three points and thus also the tilting of the positioning element about the X and Y axes. This is also referred to as detection or measurement of the tip-tilt position or tip-tilt angle of the positioning element.

Optical-interferometric sensor systems are preferably used to determine the translation in Z direction and the tip-tilt angles of a positioning element. Such sensor systems can be used to determine translations or distance changes or tilts down to the picometer range.

By combining optical incremental encoders and optical-interferometric sensor systems, for example, the translations in three spatial directions (X, Y, Z) and the rotations around the three spatial axes X, Y and Z (i.e. the tilt or tip-tilt angles and the rotation angle) of the platform of a 6D positioning device can be detected.

In optical incremental encoders, the scale element normally comprises a material measure, which is usually formed by a substantially two-dimensional grid, also called 2D grid, arranged on a surface of the scale element or on the surface of the positioning element in the form of a plurality of dots. The light of a light source of the incremental encoder is reflected at this grid or 2D-grid, whereby the position change of the positioning element can be determined from the measurement signals of the light thus reflected. The third dimension of the material measure, namely its thickness or the thickness of the individual dots, has no or only negligible influence on the corresponding position measurement.

In optical-interferometric sensor systems, the scale element normally comprises a reflection surface on which the light of a light source of the optical-interferometric sensor system is reflected, whereby, among other things, a change in distance at the respective measuring position can be inferred from differences in transit time of differently guided light beams.

U.S. Pat. No. 7,292,312 B2 describes an optical measuring device for controlling or regulating the movement of a substrate table, the optical measuring device having a combination of at least three interferometer encoder systems, and each of these interferometer encoder systems comprising a one- or two-dimensional encoder grid, an optical sensor and an interferometer. The combination of the three interferometer encoder systems provides at least six position values, with the aid of which the position and location of the substrate table can be determined.

US 2004/0263846 A1 discloses a measuring device for detecting the position of a mask table in at least one plane, the measuring device comprising at least one optical encoder read head which interacts with a corresponding diffraction grid mounted on the mask table. For the detection of further position data of the mask table, US 2004/0263846 A1 proposes the use of capacitive or optical distance sensors.

In the case of a combined sensor system comprising an optical incremental encoder and an optical-interferometric sensor system, it is conceivable that each of the two sensor systems operates or measures against a dimensional element that is unique and assigned to it. For reasons of compactness and lower complexity, however, it is more advantageous that both sensor systems only work or measure against a common scale element. However, if both sensor systems measure against the same surface of the scale element, on which both the scale element and the reflection layer are arranged, certain disadvantages result. These are primarily due to the fact that the measurement of the optical-interferometric sensor system is negatively influenced by the material measure of the incremental encoder. This is because even the small thickness or the fluctuating thickness along the alignment of the two-dimensional grid influences the highly accurate optical-interferometric measurement. In the area of a reflecting dot of the two-dimensional grid or XY-grid, for example, a distance between the sensor head of the optical-interferometric sensor system and the measuring or positioning element is measured that is smaller, depending on the height of the dot, than in the area between two adjacent or neighboring dots.

U.S. Pat. No. 8,760,622 B2 avoids this problem by proposing to provide the material measure of the incremental encoder on a different surface of the positioning element than on the surface which serves to reflect the light of the interferometric sensor system. However, the correspondingly spaced arrangement between the material measure and the reflection surface has the disadvantage that the Abbe principle is violated and additional space must be provided for the measuring system. Furthermore, this arrangement is not suitable for use with small sensor heads for measuring the distance within the limits of the incremental encoder.

Therefore, it is the object of the present invention to provide a scale element for an optical measuring device comprising the combination of an incremental encoder and an interferometric sensor system, in which both the incremental encoder and the interferometric sensor system can measure against the same surface of the scale element without the measurement of the interferometric sensor system being influenced by the material measure of the incremental encoder.

This object is solved by a scale element according to claim 1, whereby the subclaims following on from this at least represent useful further developments.

The scale element according to the invention is characterized in that it has a reflection layer on one of its surfaces, which is provided for interaction with the interferometric sensor system, and the scale element also has a material measure, which is arranged in a direction away from the reflection layer and at a distance therefrom and is provided for cooperation with the incremental encoder, the reflection layer being such that it is largely transparent for light of certain wavelengths of a first wavelength range and is completely or partially transparent for light of other wavelengths of a second wavelength range, the first wavelength range and the second wavelength range differing from one another.

Because the material measure is not formed in the same plane as the reflection layer, but at a distance from it in a direction away from the reflection layer, the material measure of the incremental encoder has no negative effect on the measurement signals detected by the interferometric sensor system. However, this is only possible in combination with the reflection layer which is partially transparent to light wavelengths, so that the wavelengths of the incremental encoder of a first wavelength range can pass through the reflection layer almost unhindered and are only reflected by the material measure below it, whereas the wavelengths of the interferometric sensor system of a second wavelength range are completely or almost completely reflected by the reflection layer.

It can be advantageous that the material measure is located on the surface of the scale element opposite the surface provided with the reflection layer. This makes it relatively easy to manufacture the scale element.

It may also be advantageous that the scale element comprises a substrate of a glass-like material. This ensures that the wavelength of the incremental encoder penetrating the material measure is not or only very slightly attenuated.

In addition, it can be advantageous that the substrate consists of a hardened sapphire glass. This can be produced in thicknesses of a few tenths of a millimeter with relatively large dimensions without any disadvantageous deformations during its use.

It can also be advantageous that the surface of the scale element on which the reflection layer is arranged has a flatness of a few tenths of a millimeter to a few micrometers, because this surface forms the reference to the interferometric sensor system. This minimizes the effort for the otherwise usual mapping of the flatness errors.

The invention also refers to an optical measuring device, in particular for high-precision position and/or location detection of a positioning element, with an incremental encoder, an interferometric sensor system and with a scale element according to one of the preceding claims.

It can be advantageous here that the incremental encoder comprises a read head, a first light source for emitting light of a first wavelength, and the material measure of the scale element associated with the read head, and the interferometric sensor system comprises a sensor head, a second light source for emitting light of a second wavelength, and the reflection layer of the scale element associated with the sensor head, the reflection layer being associated with both the read head and the scale element, and also faces the sensor head, and the reflection layer is transmissive for the light of the first wavelength and reflective for the light of the second wavelength, wherein the interferometric sensor system uses light of the second wavelength reflected by the reflection layer and detected by the sensor head for measurement and the incremental encoder uses light of the first wavelength reflected by the material measure and detected by the read head for measurement.

The scale element is preferably plate-shaped, and the incremental encoder is adapted to detect the position and location of the scale element within the plane defined by it. Furthermore, the interferometric sensor system is preferably adapted to detect the position of the scale element perpendicular to the plane defined by this scale element and the position of the scale element due to a rotation around one of the two axes running perpendicular to each other and in the plane of the scale element.

It may prove to be advantageous that the interferometric sensor system has at least three sensor heads. This makes it possible to measure both the distance and the tip/tilt angle.

Finally, the invention refers to a positioning device with a positioning element and an optical measuring device according to one of the preceding claims, the scale element being arranged on the positioning element or being an integral part of the positioning element, and the position or the location or the position and location of the positioning element being able to be inferred by means of the optical measuring device.

### BRIEF DESCRIPTION OF THE DRAWINGS

In the following description, additional features and advantages will be apparent to those skilled in the art from reading a detailed description of exemplary embodiments, as described with respect to the accompanying drawing, wherein:

FIG. 1 shows an exemplary embodiment of a scale element.

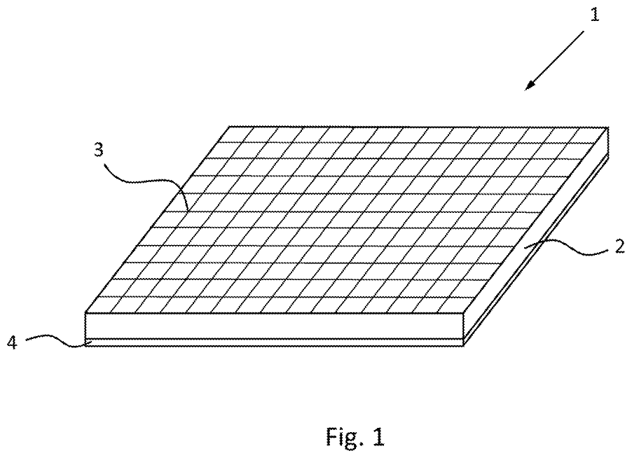

An embodiment of the invention is described below on the basis of the attached single FIG. 1. This shows a scale element 1 according to the invention with a plate-shaped geometry. The substrate 2 consists of a hardened sapphire crystal. On the surface of the substrate 2 facing upwards in FIG. 1, a scale element 3 in the form of a two-dimensional grid or a 2D-grid 3 is arranged over the entire surface. A reflection layer 4 is arranged on the surface of the substrate 2 opposite the 2D-grid 3. The reflection layer 4 has a high optical reflection at a light wavelength of 1550 nm and a high transmission at a light wavelength of 640 nm.

1. Scale element for an optical measuring device having an incremental encoder and an interferometric sensor system, wherein the scale element comprises:
a reflection layer on one of its surfaces, which is provided for cooperation with an interferometric sensor system; and
a material measure, which is arranged in a direction away from and spaced apart from the reflection layer and is provided for cooperation an incremental encoder, the reflection layer being such that it is transparent for light of certain wavelengths and reflective for light of other wavelengths.

2. Scale element according to claim 1, wherein the material measure is arranged on a surface of the scale element which is opposite to the surface provided with the reflection layer.

3. Scale element according to claim 1, wherein the scale element comprises:
a substrate of a glass-like material.

4. Scale element according to claim 3, wherein the substrate consists of hardened sapphire glass.

5. Measuring device for position and/or location detection of a positioning element, the measuring device comprising:
an incremental encoder;
an interferometric sensor system; and
a scale element according to claim 1, wherein the reflection layer is provided for cooperation with the interferometric sensor system and the material measure is provided for cooperation with the incremental encoder.

6. Measuring device according to claim 5, wherein the incremental encoder comprises:
a read head;
a first light source for emitting light of a first wavelength; and the material measure of the scale element associated with the read head, and wherein the interferometric sensor system comprises:
a sensor head;
a second light source for emitting light of a second wavelength; and the reflection layer of the scale element associated with the sensor head, the reflection layer facing both the read head and the sensor head, and the reflection layer being transmissive for the light of the first wavelength and reflective for the light of the second wavelength, wherein the interferometric sensor system is configured to use light of the second wavelength reflected by the reflection layer and detected by the sensor head for measurement, and the incremental encoder is configured to use light of the first wavelength reflected by the measuring body and detected by the reading head for measurement.

7. Measuring device according to claim 6, wherein the scale element is plate-shaped and the incremental encoder is configured and arranged to detect a position and location of the scale element within a plane defined by the scale element, and the interferometric sensor system is configured and arranged to detect a position of the scale element perpendicular to the plane defined by the scale element and a location of the scale element due to a rotation around one of two axes extending perpendicular to each other and in the plane of the scale element.

8. Measuring device according to claim 5, wherein the interferometric sensor system has at least three sensor heads.

9. Positioning device comprising:
a positioning element; and
a measuring device according to claim 5, wherein the scale element is at least one of arranged on the positioning element or is an integral part of the positioning element, and the measuring device is configured to infra a position or location, or the position and location, of the positioning element.

10. Scale element according to claim 2, wherein the scale element comprises:
a substrate of a glass-like material.

11. Scale element according to claim 10, wherein the substrate consists of hardened sapphire glass.

12. Measuring device for position and/or location detection of a positioning element, the measuring device comprising:
an incremental encoder:
an interferometric sensor system; and
a scale element according to claim 11, wherein the reflection layer is provided for cooperation with the interferometric sensor system and the material measure is provided for cooperation with the incremental encoder.

13. Measuring device according to claim 12, wherein the incremental encoder comprises:
a read head;
a first light source for emitting light of a first wavelength; and
the material measure of the scale element associated with the read head, and wherein the interferometric sensor system comprises:
a sensor head;
a second light source for emitting light of a second wavelength; and
the reflection layer of the scale element associated with the sensor head, the reflection layer facing both the read head and the sensor head, and the reflection layer being transmissive for the light of the first wavelength and reflective for the light of the second wavelength, wherein the interferometric sensor system is configured to use light of the second wavelength reflected by the reflection layer and detected by the sensor head for measurement, and the incremental encoder is configured to use light of the first wavelength reflected by the measuring body and detected by the reading head for measurement.

14. Measuring device according to claim 13, wherein the scale element is plate-shaped and the incremental encoder is configured and arranged to detect a position and location of the scale element within a plane defined by the scale element, and the interferometric sensor system is configured and arranged to detect a position of the scale element perpendicular to the plane defined by the scale element and a location of the scale element due to a rotation around one of two axes extending perpendicular to each other and in the plane of the scale element.

15. Measuring device according to claim 14, wherein the interferometric sensor system has at least three sensor heads.

16. Positioning device comprising:
a positioning element; and
a measuring device according to claim 15, wherein the scale element is at least one of arranged on the positioning element or is an integral part of the positioning element, and the measuring device is configured to infer a position or location, or the position and location, of the positioning element.
